(19) United States
(12) Patent Application Publication
(10) Pub. No.: US 2005/0204321 A1
(43) Pub. Date: Sep. 15, 2005

(54) Scan and detection systems and methods

(76) Inventor: Clemente Izurieta, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/798,676

(22) Filed: Mar. 11, 2004

(51) Int. Cl. G06F 17/50

(52) U.S. Cl. 716/4; 716/5

(57) ABSTRACT

A system for scanning a virtual layout is disclosed. One embodiment of the system includes scan and detection logic configured to scan a virtual layout to encounter a first object having first coordinates, store a second object having second coordinates in a cache, determine whether the first coordinates are outside the range of the second coordinates, and discard the second coordinates from the cache if the first coordinates are outside the range of the second coordinates.

### CROSS-REFERENCE TO RELATED APPLICATION

This application is related to copending U.S. utility patent application entitled “Object-Oriented Callback Systems and Methods” filed on the Dec. 19, 2003 and accorded Ser. No. 10/731,395, which is entirely incorporated herein by reference.

### BACKGROUND

Since the creation of the first integrated circuit in 1960, there has been an ever-increasing density of devices manufactureable on semiconductor substrates (e.g., microchips, or just “chips”). The number of devices manufactured on a chip exceeded the generally accepted definition of very large scale integration, or VLSI (e.g., more than 100,000 devices per chip), somewhere in the mid-70s. This number has grown to several million devices per chip today. Progress in VLSI manufacturing technology is likely to continue to proceed in this manner. The sequence of steps that occur in the course of manufacturing an integrated circuit can vary, but generally can be described as including a design phase and fabrication phase. In the design phase, the desired functions and necessary operating specifications of an electronics circuit are initially decided upon. Generally, the large functional blocks are first identified, followed by the selection of sub-blocks and the logic gates needed to implement the sub-blocks are chosen such that each logic gate is designed by appropriately connecting devices (e.g., transistors, resistors, etc.) that are ultimately slated for fabrication on semiconductor wafers.

Upon ensuring that the correct functionality can be achieved through the aforementioned design, the circuit is laid out. The virtual layout (also known to those skilled in the art as a physical layout or artwork) includes a set of patterns that will be transferred to the semiconductor wafer. The patterns correspond to device regions and/or interconnect structures and such patterns can be transferred to the wafers through the use of photolithographic processes and a set of masks as part of the wafer fabrication process.

Typically, the creation of the virtual layout proceeds from the “bottom up.” That is, a variety of devices are first laid out in a virtual design. Then, a set of cells representing the primitive logic gates are created by interconnecting appropriate devices. Next, sub-blocks are generated by connecting these logic gates, and finally the functional blocks are laid out by connecting the sub-blocks. The completed virtual layout is then subjected to a set of design-rule checks and propagation delay simulations to verify that correct implementation of the circuit has been achieved in virtual layout form. After this checking procedure is completed, the virtual layout information is ready to be used to generate a set of masks that will serve as tools for specifying the circuit pattern on semiconductor wafers. For VLSI circuits, virtual layout information is preferably stored in a computer.

Scan-based or line-sweep methods are traditional mechanisms used to traverse the virtual layout of a chip in search of design flaws, such as connectivity flaws like electrical shorts between circuit objects (structures), etc. These traversals are implemented internally to a computer on the virtual layout, and are typically incremental in nature. The traversal mechanisms typically traverse the virtual layout from bottom to top (in the y direction) and from left to right (in the x direction) in a traditional Cartesian plane. As the traversal occurs, various analysis algorithms can be implemented by one or more client applications to determine the nature of the detected design flaw. For example, an analysis algorithm may be used to identify every time two rectangle shapes (e.g., the rectangle shapes representing circuitry for the chip layout under evaluation) overlap or touch. Such an overlap could represent a short in a circuit. Since the number of rectangles used to represent real-world designs of the virtual layout of a chip can be on the order of one million per metal layer, the tasks of scanning and detecting can consume considerable time and resources.

### SUMMARY

One embodiment of the invention comprises a method for analyzing a virtual layout of a semiconductor chip comprising scanning a virtual layout to encounter a first object having an x-coordinate and a y-coordinate; determining whether the y-coordinate of the first object is beyond a y-coordinate of a second object that has an x-coordinate and the y-coordinate stored in a cache; and discarding the x-coordinate and the y-coordinate of the second object from the cache if the y-coordinate of the first object is beyond the y-coordinate of the second object.

Another embodiment of the invention comprises a method for analyzing a virtual layout of a semiconductor chip comprising scanning a virtual layout using a semi-greedy algorithm and detecting an event.

Another embodiment of the invention comprises a system for scanning a virtual layout of a microchip design comprising scan and detection logic configured to scan a virtual layout to encounter a first object having first coordinates, store a second object having second coordinates in a cache, determine whether the first coordinates are outside the range of the second coordinates, and discard the second coordinates from the cache if the first coordinates are outside the range of the second coordinates.

Another embodiment of the invention comprises a scan and detection system comprising means for traversing a virtual layout of a microchip design; means for detecting whether a first object has coordinates within a range of coordinates of a second object stored in a cache; and means for discarding the coordinates of the second object when the first object has coordinates outside the range of coordinates of the second object.

Another embodiment of the invention comprises a computer-readable medium having a computer program for scanning and detecting connectivity between structures in a virtual layout, the program comprising logic configured to scan objects of a virtual layout using a semi-greedy algorithm and logic configured to detect an event.

### BRIEF DESCRIPTION OF THE DRAWINGS

The components in the drawings are not necessarily to scale, emphasis instead being placed upon clearly illustrating the principles of the disclosed systems and methods. Moreover, in the drawings, like reference numerals designate corresponding parts throughout the several views.

FIG. 1A is a schematic diagram that provides a conceptual illustration of the scan and traversal mechanisms for an embodiment of the semi-greedy scan and detection system.

FIG. 1B is a schematic diagram of an example implementation for an embodiment of a semi-greedy scan and detection system.

FIG. 2A is a block diagram of an embodiment of the semi-greedy scan and detection system shown in FIG. 1B.

FIG. 2B is a block diagram of an another embodiment of the semi-greedy scan and detection system shown in FIG. 1B.

FIGS. 3A-3G are schematic diagrams that conceptually illustrate an embodiment of the semi-greedy feature of the semi-greedy scan and detection system shown in FIGS. 2A and 2B as a traversal of a virtual layout in the x and y-directions and detection for connectivity flaws are implemented.

FIG. 4 is a Unified Modeling Language Information diagram of an embodiment of an example software architecture of the semi-greedy scan and detection system shown in FIGS. 2A-2B as used in an artificial intelligence implementation.

FIG. 5 is a schematic diagram used to illustrate an embodiment of a realization in memory of the example software architecture of the semi-greedy scan and detection system shown in FIG. 4.

FIG. 6 is a flow diagram that illustrates an embodiment of a scanning and connectivity flaw detection methodology of the software architecture shown in FIG. 4.

FIG. 7 is a flow diagram that further illustrates an embodiment of the connectivity flaw detection step illustrated in FIG. 6.

FIG. 8 is a flow diagram that illustrates an embodiment of a scanning and connectivity flaw detection methodology of the semi-greedy scan and detection system of FIGS. 2A-2B.

FIG. 9 is a flow diagram that illustrates an embodiment of a generalized scanning and design flaw detection methodology of the semi-greedy scan and detection system of FIGS. 2A and 2B.

### DETAILED DESCRIPTION

Disclosed herein are various embodiments of a scan and detection system and method, herein referred to as a semi-greedy scan and detection system. The semi-greedy scan and detection system may include a scanning algorithm or algorithms that enable the traversing of virtual layouts of semiconductor microchips (referred to herein as chips) and/or the reporting of events such as design flaws of chip virtual layouts and/or other types of events. This traversal is implemented internally to the computer, and can occur with or without user interaction during the traversal process. The semi-greedy scan and detection system may detect segment and/or geometric figure intersections (examples of design flaws) of the virtual layout of a chip design to identify electrical connectivity flaws, rule violations (electrical or physical), routes across metal layers, among other design flaws. Thus, design flaws may include connectivity flaws (e.g., electrical connectivity that may result in an electrical short), such as overlaps between circuit objects (virtual layout structures) where an area is shared, touching between objects (e.g., where objects share a common coordinate), etc. Although the semi-greedy scan and detection system will be described in the context of detecting events such as design flaws, it will be understood that other events can be detected. Such events may include features of interest in a virtual layout of a chip design that may be preliminary steps to the actual detection of flaws, such as when an object, or object parameter (e.g., first edge detected), is first encountered by a scan or last encountered by a scan. The semi-greedy scan and detection system may reduce the number of geometric figures, which represent the circuit objects, to be considered at any given point and help optimize a core traversal engine.

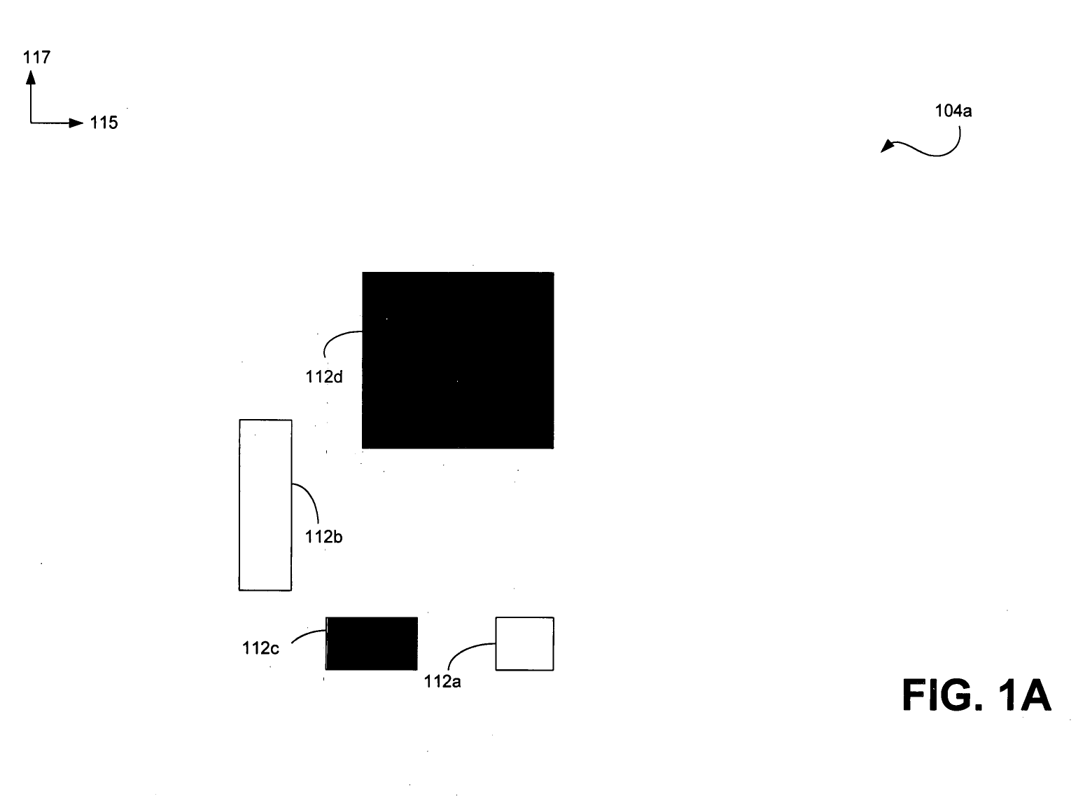

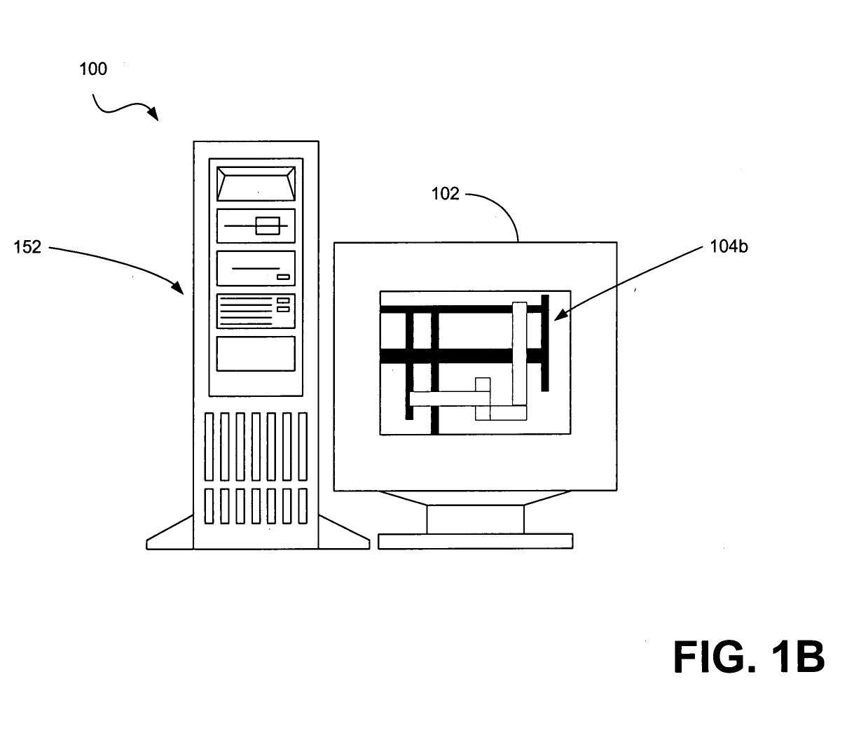

The scan and detection process can be better understood by considering an example. Referring to FIG. 1A, an example virtual layout 104a is illustrated. The virtual layout 104a in this example is displayed as a top-plan view. The clear or non-colored rectangles 112a and 112b represent a first layer of objects. The black or colored rectangles 112c and 112d represent a second layer of objects disposed beneath the first layer. The rectangles may represent virtual circuits, virtual circuit components, and/or virtual interconnections. Although the semi-greedy scan and detection system approaches event detection as a 3-dimensional problem, the virtual layout 104a is represented in a 2-dimensional plane. For example, if a user implementing the semi-greedy scan and detection system on a particular virtual layout chooses to evaluate design flaws in multiple layers, the multiple layers can be “collapsed” or “flattened,” resulting in what appears as a 2-dimensional plane of rectangles.

In one embodiment, a scan traversal (implemented internally to a computer) can progress from rectangle to rectangle, starting at the leading edge (e.g., represented as the lower-left corner) of the lowest rectangle (rectangle 112c) encountered in the virtual layout 104a. The traversal may then proceed along the same x-coordinate in the x-direction 115 to the leading edge of the next rectangle (rectangle 112a). An evaluation for connectivity flaws can occur between rectangles 112a and 112c, and as shown, none is detected. The next traversal returns to what is represented as the left-side of the virtual layout 104a with an incremental traversal in the y-direction 117 to encounter the leading edge of the next lowest rectangle (rectangle 112b). Once the top-edge of rectangles 112c and 112a (their top-edges being at the same height) has been exceeded, no connectivity flaw can occur between rectangles 112a, 112b, and 112c. Thus, scan traversals and design flaw detection can continue starting at rectangle 112b and “looking forward” without consideration of rectangles 112c and 112a, and thus without burdening cache memory or processing speed. In other words, rectangles 112b and 112d have bottom-edge y-coordinates beyond the top-edge y-coordinates of rectangles 112a and 112c, and thus are not capable of being involved in a connectivity flaw with rectangles 112a and 112c. In keeping with the above, the amount of data under consideration continually shrinks and grows depending on whether the corresponding rectangles can potentially be the subject of a design flaw for a defined scan traversal. In a chip artwork where millions of rectangles (representing circuits or circuit components, such as transistor(s) and/or resistor(s), etc.) are resident in computer memory, the discarding of data speeds processing and provides more efficient detection since there is less data to consider at each step of the traversal.

A few terms will be defined below to describe the concepts conceptually illustrated in FIG. 1A. A “greedy algorithm” as used herein refers to a methodology used to solve optimization problems. A greedy algorithm uses all locally available data to make decisions that guide the algorithm to a solution, such as to whether a virtual layout includes design flaws. A greedy algorithm has at least two properties, referred to as a greedy choice property and an optimal structure property. The greedy choice property refers to the premise that a globally-optimal solution can be determined by making a locally optimal, or “greedy,” choice. The optimal structure property refers to the premise that a problem exhibits an optimal substructure if an optimal solution to the problem contains within it (i.e., the solution) optimal solutions to subproblems.

A “semi-greedy algorithm” as used herein is a “relaxed” or less restrictive form of a greedy algorithm. A semi-greedy algorithm at least preserves the two properties of the greedy algorithm indicated above. The semi-greedy algorithm is designated “semi-greedy” however because of the growth potential for the local set of data used to make decisions. This latter feature may result in local choices evaluating larger data sets than would be evaluated by a greedy algorithm. In other words, the amount of locally-available data may grow beyond a threshold, the value of which is typically application-specific, beyond which may no longer be considered local by a greedy algorithm.

Thus, in the context of scanning microchip data, the semi-greedy algorithm of the semi-greedy scan and detection system preserves the greedy choice property at least because the optimal solution is reached by making choices based on local data. However, this local data may grow to be more “global” in nature, such as in vertically-layed virtual layouts (e.g., rectangles with expansive y-direction orientations). The semi-greedy algorithm of the semi-greedy scan and detection system also preserves the optimal structure property because as a sweep or scan of the virtual layout occurs, an optimal solution exists up to the point of the scan traversal.

The semi-greedy scan and detection system determines the boundaries of virtual layout structures, or circuit objects, in each layer of a chip design. The circuit objects are generated in a computer. The circuit objects may represent circuits, circuit components, and/or interconnections, and can be expressed using data that defines geometric figures, such as a rectangle and/or other geometric figures as illustrated in FIG. 1A. For example, each rectangle has a left and a right edge. Also, each rectangle has a height, a bottom, and a top edge. Further, there may be any number of layers (e.g., representing metal layers) in the virtual layout of a chip. The semi-greedy scan and detection system thus approaches the scan and detection of chip design flaws as a three-dimensional problem, and one of the goals may be to locate all rectangles that contact each other (e.g., share a data coordinate stored in the computer) across one or more layers.

One way the semi-greedy scan and detection system may reduce the data under consideration is by continually caching coordinate data to evaluate the positions of rectangles encountered during a scan traversal that may be involved in a design flaw (such as an overlap of rectangles), while discarding, disregarding, or otherwise ignoring the coordinate data of rectangles that can no longer be the subject of a design flaw. It will be understood herein that the disregarding, removing, discarding, or the like, of data as used herein refers to the fact that the semi-greedy scan and/or detection algorithms do not include or consider the rectangle data coordinates that can no longer be the subject of a design flaw at the lead point and beyond of the scan traversal, although such coordinates may still be retained in memory. The “lead point” of the scan traversal refers to the most recently traversed Cartesian coordinates of a rectangle during the scan traversal.

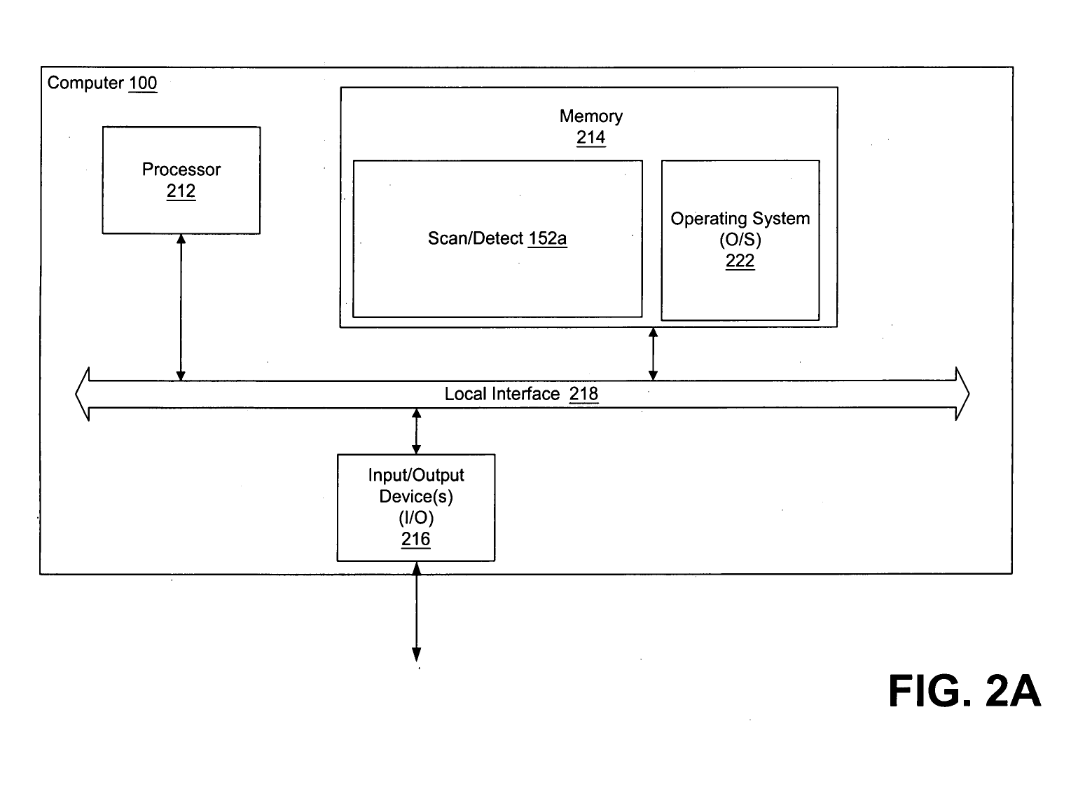

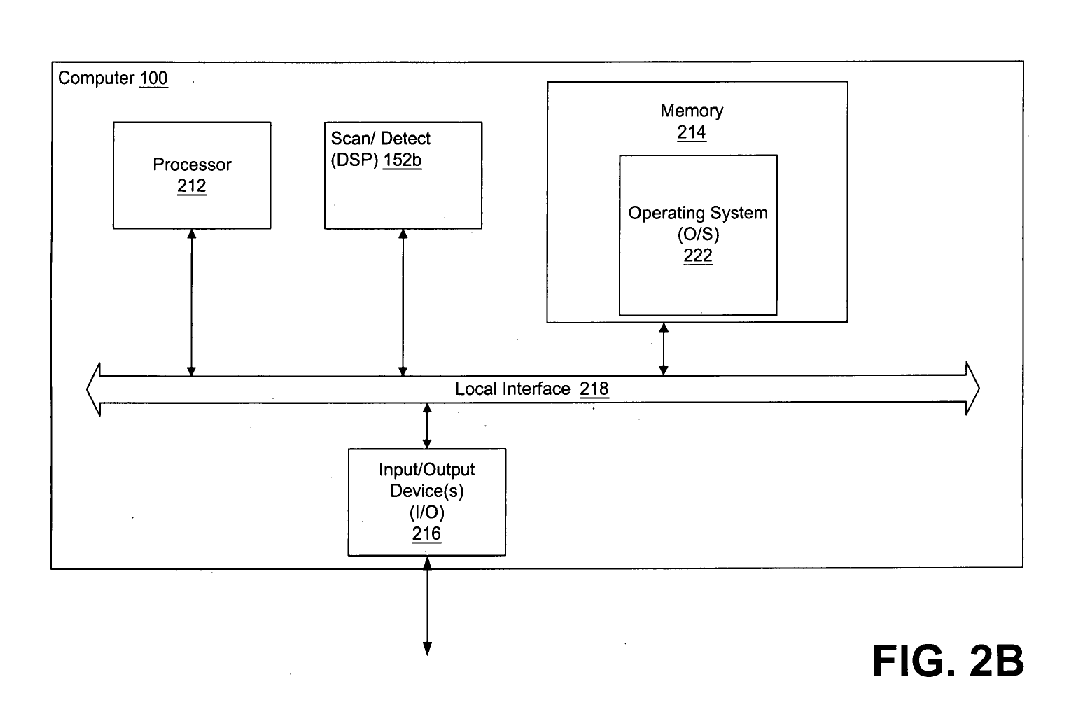

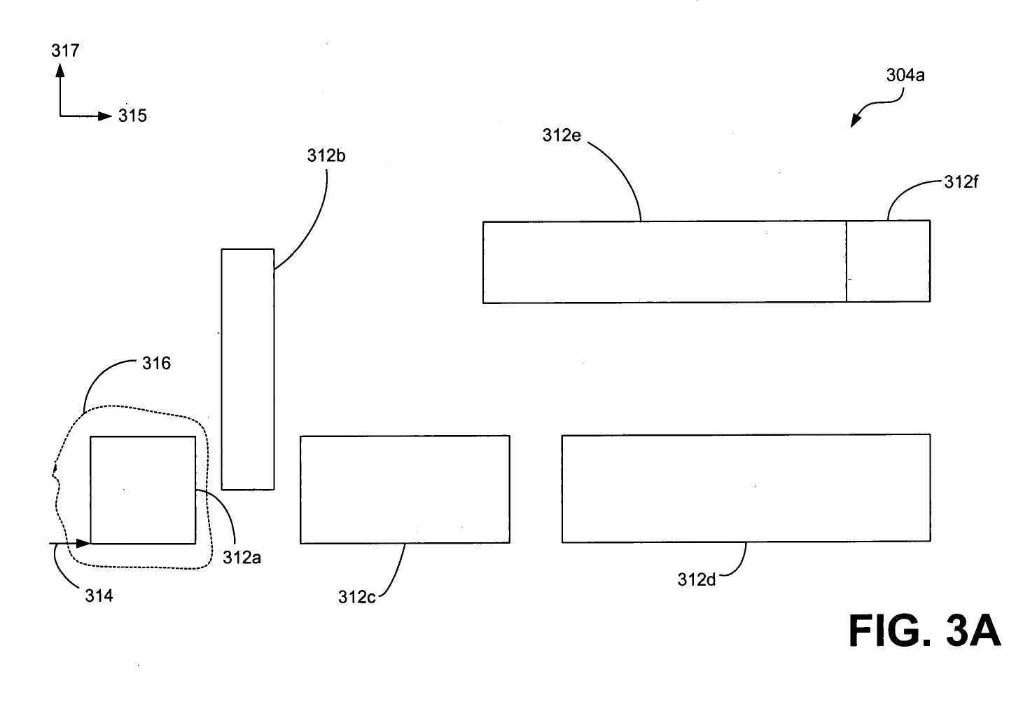

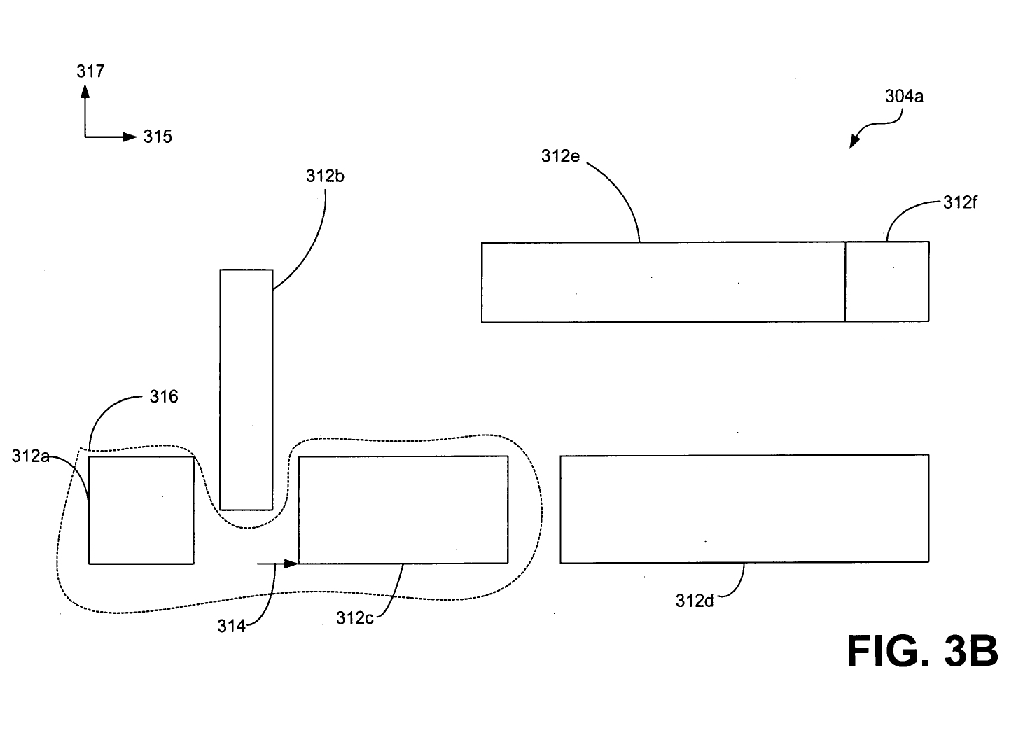

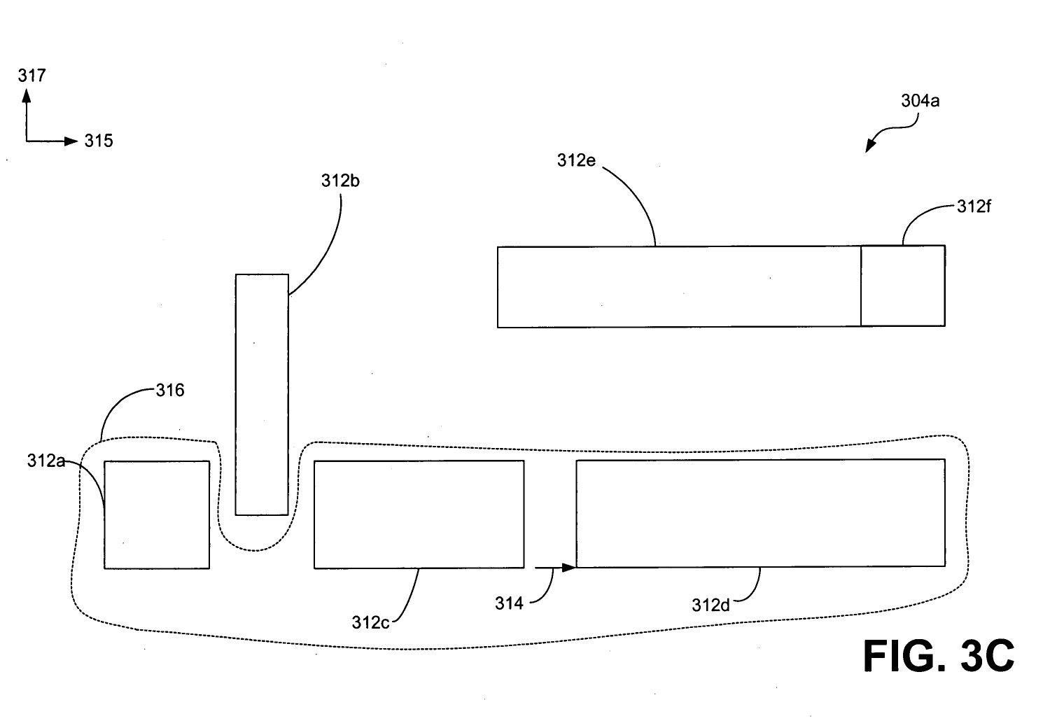

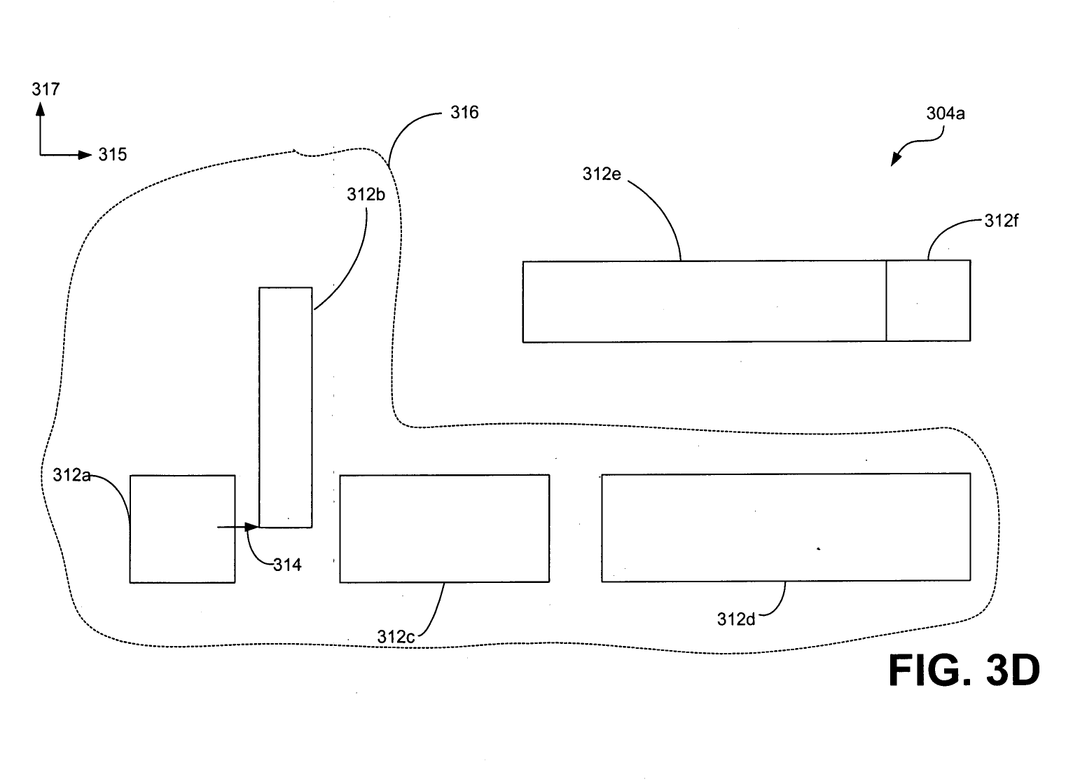

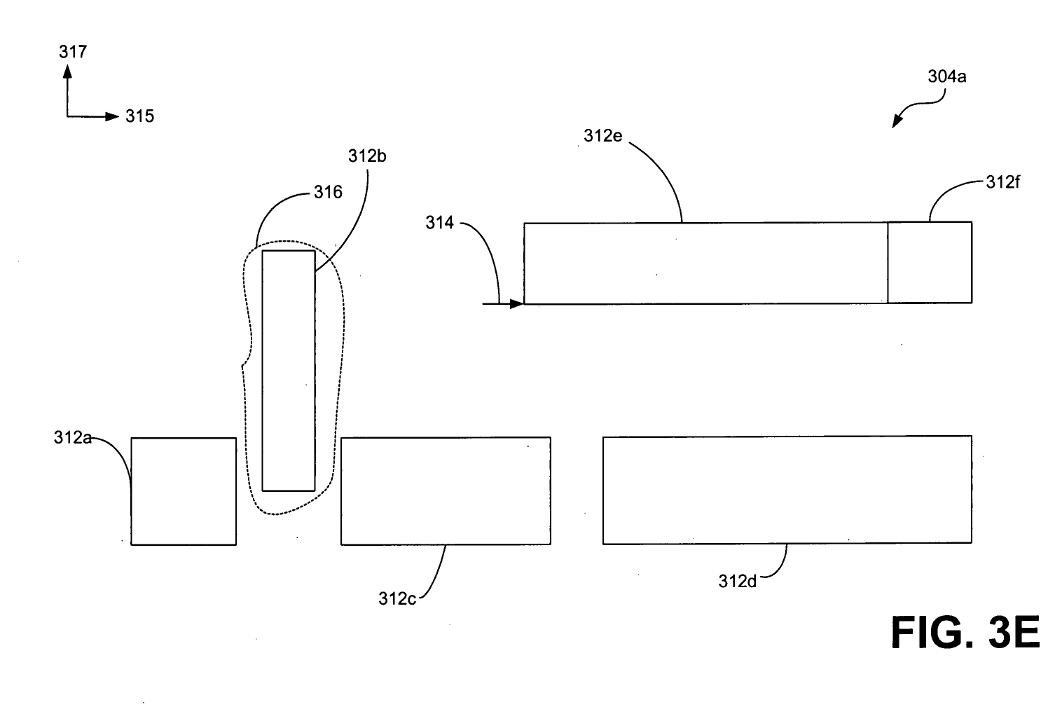

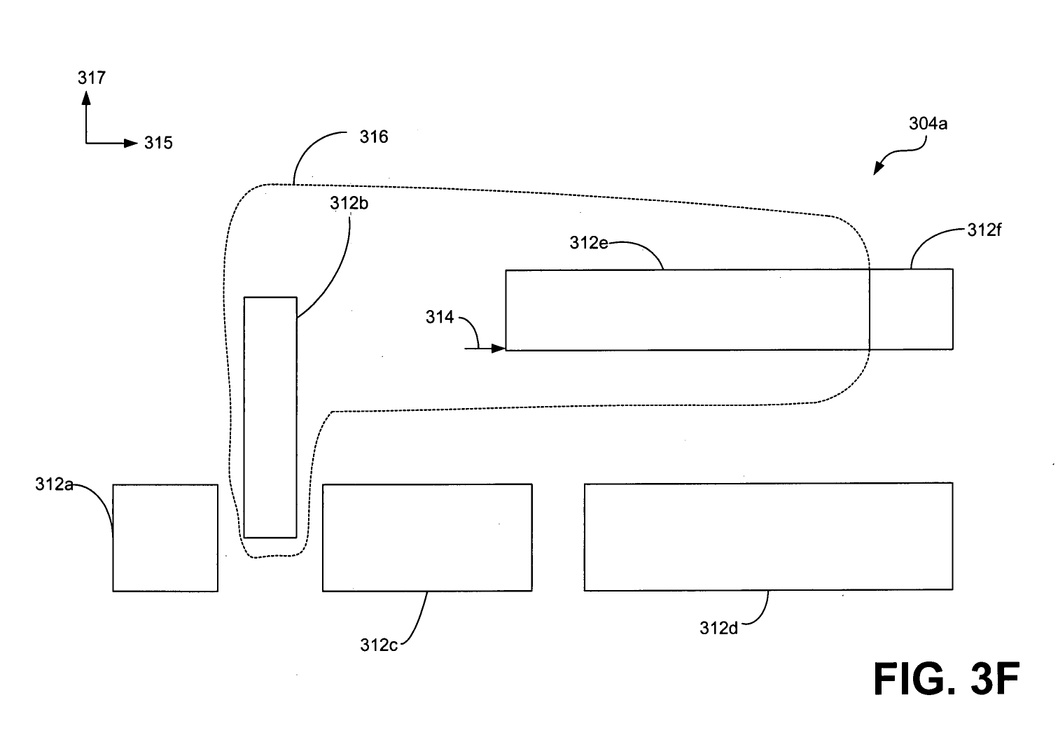

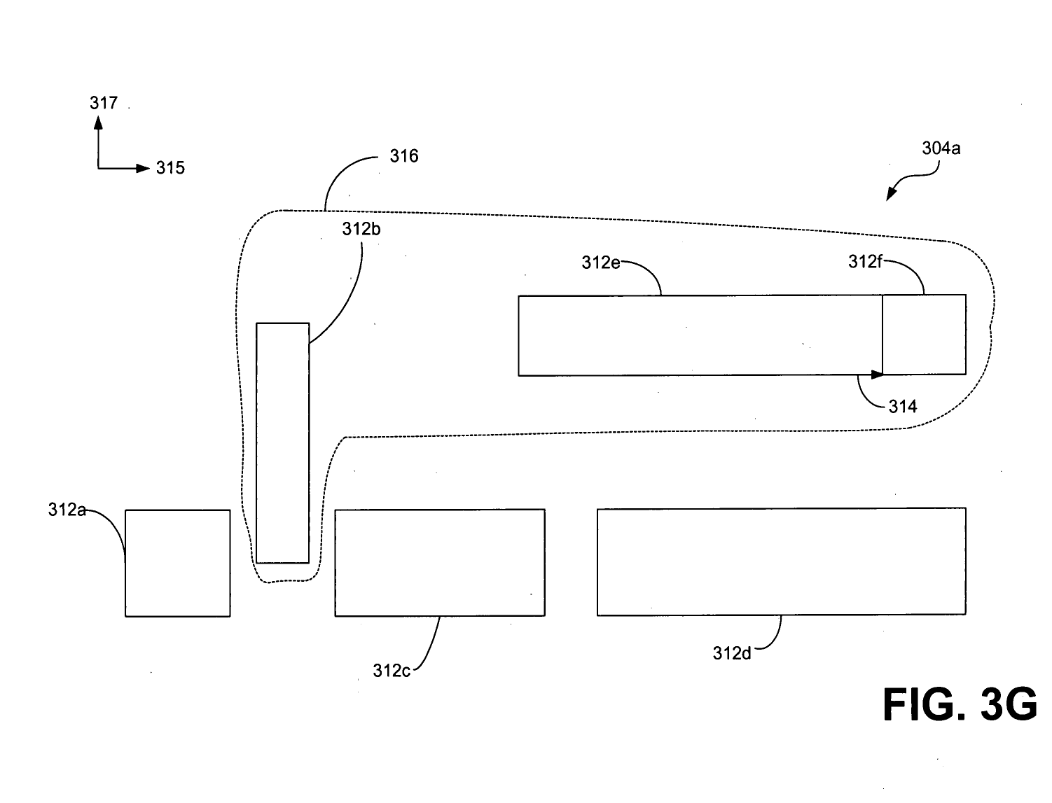

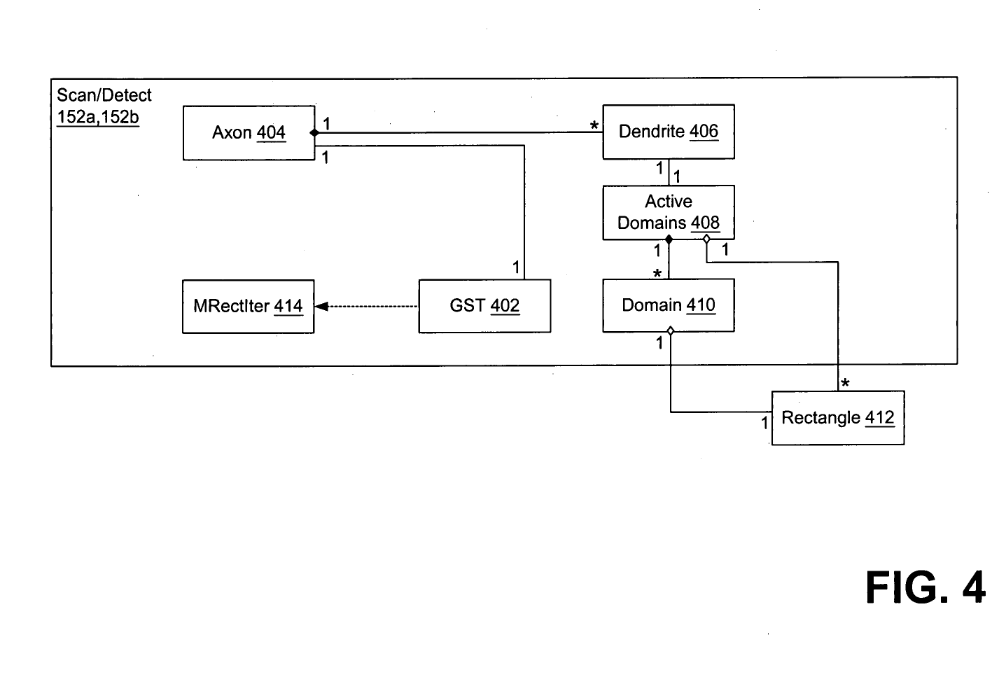

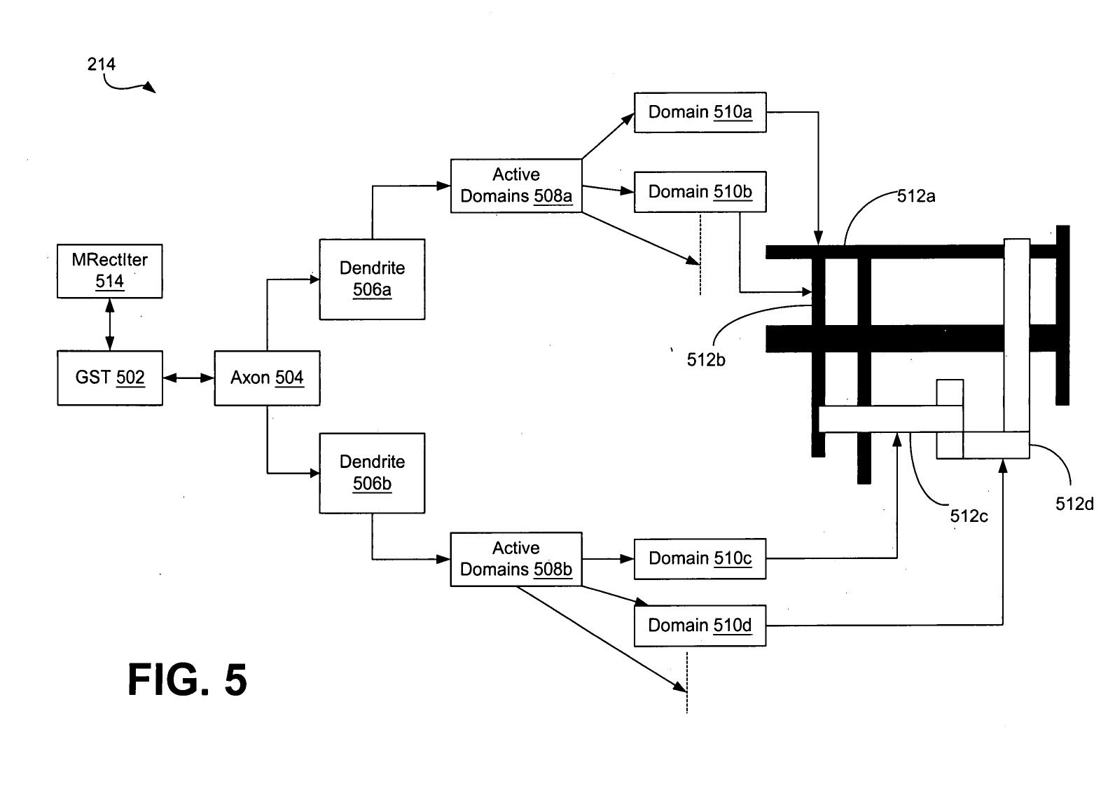

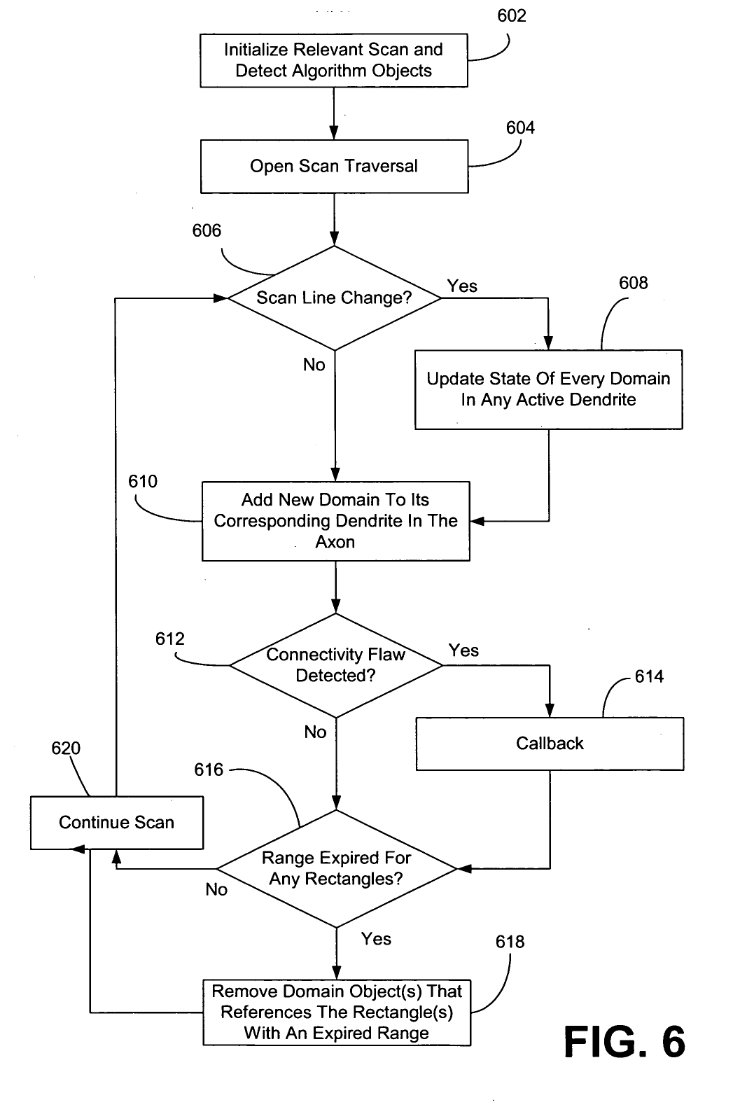

An example implementation for a semi-greedy scan and detection system is described in the following relative to FIG. 1B, followed by an illustration of some embodiments for a semi-greedy scan and detection system relative to FIGS. 2A-2B. FIGS. 3A-3G provide a broad, conceptual illustration of the traversal mechanisms of a semi-greedy scan and detection system as implemented internally to a computer. An artificial intelligence (AI) implementation that illustrates an example architecture of a semi-greedy scan and detection system is shown in FIGS. 4 and 5. FIGS. 6-9 are flow diagrams that illustrate methodologies (e.g., algorithms) that may be implemented by a semi-greedy scan and detection system.

A semi-greedy scan and detection system will be described below in the context of VLSI CAD (very large scale integration, computer-aided design) tools, with the understanding that other systems and/or implementations that may benefit from an optimized scan and detection are possible, such as multi-layer capacitance extraction to calculate overlap, fringing, and shielding interactions between multiple layers, and as tools to perform multiple logical operations (And, Or, AndNot, etc.) as one command to eliminate or significantly reduce multiple passes through shape data, among others.

FIG. 1B is a schematic diagram that depicts a computer 100 that serves as an example implementation for a semi-greedy scan and detection system. The computer 100 can be a general purpose or special digital computer, such as a personal computer (PC; IBM-compatible, Apple-compatible, or otherwise), workstation, minicomputer, or mainframe computer. The computer 100 may be in a stand-alone configuration or may be networked with other computers. The computer 100 includes a display terminal 102 that can provide images of a virtual layout 104b for a semiconductor chip, such as a VLSI chip. During the design process of VLSI chips, circuit designs are converted to the virtual layout 104b, which is now ready for additional testing and/or detection of connectivity flaws before preparing masks. Although the virtual layout 104b is shown on the display terminal 102 suggesting user-interaction in the implementation of the semi-greedy scan and detection system, embodiments of the semi-greedy scan and detection system may be implemented in a manner that is transparent, in whole or in part, to the user. The virtual layout 104b shown on the display terminal 102 can be displayed in a variety of perspectives as is generally true for computer-aided design displays.

The semi-greedy scan and detection system can be implemented in software, firmware, hardware, or a combination thereof. In some embodiments, the semi-greedy scan and detection system is implemented in software, as an executable program that is executed by the computer 100.

FIG. 2A is a block diagram showing a configuration of the computer 100 implementing a semi-greedy scan and detection system. In FIG. 2A, a semi-greedy scan and detection system is denoted by reference numeral 152a. Generally, in terms of hardware architecture, the computer 100 includes a processor 212, memory 214, and one or more input and/or output (I/O) devices 216 (or peripherals) that are communicatively coupled via a local interface 218. The local interface 218 may be, for example, one or more buses or other wired or wireless connections. The local interface 218 may have additional elements such as controllers, buffers (caches), drivers, repeaters, and receivers, to enable communication. Further, the local interface 218 may include address, control, and/or data connections that enable appropriate communication among the aforementioned components.

The processor 212 is a hardware device for executing software, particularly that which is stored in memory 214. The processor 212 may be any custom made or commercially available processor, a central processing unit (CPU), an auxiliary processor among several processors associated with the computer 100, a semiconductor-based microprocessor (in the form of a microchip or chip set), a macroprocessor, or generally any device for executing software instructions.

The memory 214 may include any one or combination of volatile memory elements (e.g., random access memory (RAM)), for example for caching of local data in a semi-greedy manner, and nonvolatile memory elements (e.g., ROM, hard drive, etc.), for example for the storage of the data corresponding to the virtual layout (e.g., virtual layout 104b). Moreover, the memory 214 may incorporate electronic, magnetic, optical, and/or other types of storage media. Note that the memory 214 may have a distributed architecture in which where various components are situated remote from one another but may be accessed by the processor 212.

The software in memory 214 may include one or more separate programs, each of which comprises an ordered listing of executable instructions for implementing logical functions. In the example of FIG. 2A, the software in the memory 214 includes the semi-greedy scan and detection system 152a according to an embodiment of the present invention and a suitable operating system (O/S) 222. The operating system 222 essentially controls the execution of other computer programs, such as the semi-greedy scan and detection system 152a, and provides scheduling, input-output control, file and data management, memory management, and communication control and related services.

The semi-greedy scan and detection system 152a is a source program, executable program (object code), script, or any other entity comprising a set of instructions to be performed. As is described below, the semi-greedy scan and detection system 152a can be implemented, in one embodiment, as a distributed network of modules, where one or more of the modules can be accessed by one or more applications or programs or components thereof. In other embodiments, the semi-greedy scan and detection system 152a can be implemented as a single module with all of the functionality of the aforementioned modules. When a source program, then the program is translated via a compiler, assembler, interpreter, or the like, which may or may not be included within the memory 214, so as to operate properly in connection with the O/S 222. Furthermore, the semi-greedy scan and detection system 152a can be written with (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 216 may include input devices such as, for example, a keyboard, mouse, scanner, microphone, etc. Furthermore, the I/O devices 216 may also include output devices such as, for example, a printer, display, etc. Finally, the I/O devices 216 may further include devices that communicate both inputs and outputs such as, for instance, a modulator/demodulator (modem; for accessing another device, system, or network), a radio frequency (RF) or other transceiver, a telephonic interface, a bridge, a router, etc.

When the computer 100 is in operation, the processor 212 is configured to execute software stored within the memory 214, to communicate data to and from the memory 214, and to generally control operations of the computer 100 pursuant to the software. The semi-greedy scan and detection system 152a and the O/S 222, in whole or in part, but typically the latter, are read by the processor 212, perhaps buffered within the processor 212, and then executed.

When the semi-greedy scan and detection system 152a is implemented in software, as is shown in FIG. 2A, it should be noted that the semi-greedy scan and detection system 152a can be stored on any computer-readable medium for use by or in connection with any computer-related system or method. In the context of this document, a computer-readable medium is an electronic, magnetic, optical, or other physical device or means that can contain or store a computer program for use by or in connection with a computer related system or method. The semi-greedy scan and detection system 152a can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In an alternative embodiment, where the semi-greedy scan and detection system 152a is implemented in hardware, the semi-greedy scan and detection system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc; or can be implemented with other technologies now known or later developed.

FIG. 2B is a block diagram of another embodiment wherein the functionality of the semi-greedy scan and detection system is implemented in a digital signal processor 152b. Like components to those shown in FIG. 2A are shown and therefore not described in the following description.

The semi-greedy scan and detection system 152a, 152b (FIGS. 2A and 2B) includes a traversal engine (not shown) that traverses a virtual layout, such as the virtual layout 104b shown in FIG. 1B, in the x and y-direction to detect connectivity flaws. The traversal engine may be an engine class (software module in object oriented programming). FIGS. 3A-3G are schematic diagrams that provide a conceptual illustration of an example scan and detection methodology employed by the semi-greedy scan and detection system 152a, 152b to detect connectivity flaws between rectangles. For purposes of illustration, the connectivity flaws of interest will be when two rectangles “touch” (share a data coordinate). As explained above, other design flaws or events can be detected depending on the needs of the user. Referring to FIG. 3A, shown is a schematic diagram of a virtual layout 304a as viewed in a x-y plane in a top plan view orientation. The virtual layout 304a includes rectangles 312a-312f, which, as similarly described above for the virtual layout 104b, represent physical structures and/or interconnections in the virtual layout 304a.

The rectangles 312a-312f are represented as being situated in a single layer (and therefore are like-colored). A coordinate system can be defined by x,y coordinates relative to a reference value at an origin (e.g., 0,0). Therefore, the position of each rectangle may likewise be defined by such coordinates. An arrowhead 314 represents the lead point (or scan line) for a scan traversal of the virtual layout 304a as the scan traversal progresses from rectangle to rectangle in the virtual layout 304a. As indicated above, the scan traversal of a virtual layout can be performed by a computer in a manner that is transparent, in whole or in part, to the user. Thus, the virtual layout 304a may be described internally as coordinate data in memory, and a scan algorithm incrementally traverses the layout from object (e.g., rectangle) to object with this incremental traversal conceptually represented by the arrowhead 314 pointing to the most recent object coordinates of interest. In one embodiment, the scan is implemented by progressing in the x-direction 315 from a “leading edge” (e.g., the bottom-left edge in the orientation of FIG. 3A) of a first rectangle to the leading edge of a second rectangle in the same x-coordinate of the entire virtual layout 304a. For example, the arrowhead 314 traverses the first row of rectangles (312a, 312c, and 312d) from the leading edge of rectangle 312a to the leading edge of rectangle 312c and then to the leading edge of rectangle 312d. As the scan progresses in the x-direction 315, each rectangle has coordinate data that is cached for consideration of whether there is a touch detected between the other cached rectangles, and whether there is rectangle coordinate data to discard, as explained below. At the completion of the x-direction traversal (e.g., after the caching of coordinate data for rectangle 312d and evaluation for touches in FIG. 3C), the scan traversal progresses in the y-direction 317 (e.g., illustrated in FIG. 3D as progressing from bottom to top (317) to the leading edge of rectangle 312b). Next, an evaluation for whether there is rectangle coordinate data to discard from the cache occurs, the coordinate data of rectangle 312b is cached, and an evaluation is made to determine whether the rectangle 312b is touching the other cached rectangles (e.g. 312a, c, and d). Other traversal directions and/or sequences are contemplated to be within the scope of the invention (e.g., top-to-bottom, right-to-left, etc.). A dashed line 316 is shown in FIG. 3A that identifies the local rectangle coordinate data (e.g., cached data) under evaluation, in this case, the coordinate data of rectangle 312a.

Thus in operation, a scan traversal initially encounters the leading edge of rectangle 312a, as indicated by arrowhead 314. The semi-greedy scan and detection system 152a, 152b (FIGS. 2A and 2B) caches the coordinate data describing the boundaries of rectangle 312a for evaluation of touches with other rectangles, as represented by the dashed line 316.

Referring to FIG. 3B, the scan has progressed in the x-direction 315 to the leading edge of the next rectangle, rectangle 312c (illustrated by arrowhead 314). The semi-greedy scan and detection system 152a, 152b (FIGS. 2A and 2B) caches the coordinate data describing the boundaries of rectangle 312c for evaluation with the retained coordinate data of rectangle 312a as represented by the dashed line 316. The coordinate data of rectangle 312a are retained since rectangle 312a can potentially touch another rectangle whose coordinate data is cached while the scan traversal remains at or below the top edge (in the orientation of FIG. 3B) of rectangle 312a. Once the top edge of a rectangle has been exceeded by a scan traversal, that rectangle can no longer touch another rectangle for the rest of the scan traversal. In this example, the semi-greedy scan and detection system 152a, 152b (FIGS. 2A and 2B) evaluates whether rectangle 312a touches rectangle 312c. As shown in FIG. 3B, no touches are detected.

Referring to FIG. 3C, the scan traversal has progressed to the leading edge of rectangle 312d, as represented by arrowhead 314. The semi-greedy scan and detection system 152a, 152b (FIGS. 2A and 2B) caches the coordinate data describing the boundaries of rectangle 312d for evaluation with the retained coordinate data of rectangles 312a and 312c as represented by the dashed line 316. As shown, the data under evaluation for detecting touches has grown to include the coordinate data of rectangles 312a, 312c, and 312d. Upon completing the evaluation for touches using the cached coordinate data, the traversal incrementally changes in the y-direction 317 to the leading edge of the next rectangle 312b closest to the x-coordinate origin (the left-most rectangle in FIG. 3D).

At this point, the semi-greedy scan and detection system 152a, 152b (FIGS. 2A and 2B) determines whether there is any rectangle coordinate data to discard from the cache, since rectangles with such coordinate data will not touch rectangle 312b. One mechanism to determine whether to discard coordinate data is to evaluate whether the leading edge of rectangle 312b is higher than (higher in the y-direction 317 in the orientation shown in FIG. 3D) the top-edge of the rectangles having cached coordinate data (e.g., rectangles 312a, 312c, and 312d). If the top edges of the rectangle or rectangles having cached coordinate data are lower than the leading edge of rectangle 312b, then the cached coordinate data for such rectangle or rectangles are discarded and the rectangle coordinate data for rectangle 312b is added to the cache. In this example, the top edges of the rectangles having cached coordinate data are located above the leading-edge of rectangle 312b, and thus the coordinate data of rectangles 312a, 312c, and 312d remain cached and the coordinate data of rectangle 312b is added to the cache. Additionally, the rectangles having coordinate data in the cache are evaluated for touches, which as shown, are not existent in this example. Note that rectangle 312b is a “vertically-laid” rectangle, and consistent with the semi-greedy feature, may cause the “local” data to appear “global” if its length extends considerably in the y-direction 317.

Referring to FIG. 3E, an incremental change in the y-direction 317 to the next rectangle (rectangle 312e) has resulted in the scan traversal exceeding the top edges of rectangles 312a, 312c, and 312d. At this point, the coordinate data corresponding to rectangles 312a, 312c, and 312d is discarded (removed from the cache), with coordinate data for rectangle 312b comprising the local data under evaluation for determining the presence of touches. Thus, the local data under consideration has shrunk. The coordinate data for rectangle 312e is then cached for evaluation with rectangle 312b, as shown in FIG. 3F. In other words, the semi-greedy scan and detection system 152a, 152b (FIGS. 2A and 2B) caches the coordinate data describing the boundaries of rectangle 312e for evaluation with the retained coordinate data of rectangle 312b as represented by the dashed line 316, enabling evaluation for touches between rectangles using less coordinate data than the data used in the scan and detection illustrated in FIG. 3D. Scan traversal continues in the x-direction 315 to the leading edge of rectangle 312f as shown in FIG. 3G.

Referring to FIG. 3G, in similar fashion, the semi-greedy scan and detection system 152a, 152b (FIGS. 2A and 2B) determines whether the leading edge of rectangle 312f has exceeded the top edge of the other rectangles having cached coordinate data. Then the coordinate data of rectangle 312f is added to the cache, as indicated by the dashed line 316, and an evaluation is made for the existence of touches between the other rectangles having cached coordinate data. In this example, a touch has been detected between rectangle 312f and rectangle 312e.

Note that a design flaw, such as a connectivity flaw (e.g., an overlap, touch, etc.), can occur between layers and/or within a layer. Such a connectivity flaw can be evidence of a short in the virtual layout 304a that is in need of correction. Responsive to detecting a touch between rectangles, for example, the semi-greedy scan and detection system 152a, 152b (FIGS. 2A and 2B) can alert a user of the touch (e.g., via a user interface screen) and/or interface with another application or one or more modules to enable the commencement of notification and/or remedial measures, and/or other actions as needed. The notification to a user or other entity may include, for example, the x-y coordinates of the rectangles of the virtual layout 304a corresponding to the location where the touch was detected. Further information about the reporting of design flaws and other events can be found in the application referenced in the “Cross-Reference to Related Application” section.

FIG. 4 is a Unified Modeling Language Information diagram of an embodiment of an example software architecture of the semi-greedy scan and detection system 152a, 152b shown in FIGS. 2A-2B, as used in an artificial intelligence implementation. UML Information diagrams are typically used by programmers to describe the “blue-print” or architecture of objects in memory. Accordingly, FIG. 4 provides further insight into the underlying software mechanisms of the semi-greedy scan and detection system 152a, 152b. Each “block” in FIG. 4 (e.g., block labeled “Axon 404”) represents a “class” in object-oriented terminology, or a “data structure” in traditional procedural language terminology. In one embodiment, each class can be implemented as separate modules that can be used by other programs. The modules can be collectively referred to as the semi-greedy scan and detection system 152a or 152b (Scan/Detect 152a, 152b). A rectangle class 412 corresponding to the rectangles of a virtual layout is illustrated as being a module distinct from the modules comprising the semi-greedy scan and detection system 152a, 152b, although this is not necessarily so. All modules of these classes can be located in memory 214 (FIG. 2A). The modules can also be implemented with different data structures, such as linked lists and tree structures. The modules of these classes can be combined into a single applications program or distributed in multiple applications programs. Cardinality symbols are also shown in FIG. 4 represented by a “1” and a “*”. For example, the two 1's between the dendrite class 406 and the active domains class 408 reveal that for every instance of a dendrite class 406, there is an instance of an active domains class 408 (e.g., a 1:1 correspondence). An object is an instance of a class. As another example, the 1 and the * between the axon class 404 and the dendrite class 406 reveals that for every instance of an axon class 404, there is one or more instances of a dendrite class 406 (the “*” signifying one or more). FIG. 4 thus provides a decomposition of the classes that cooperate with the traversal engine class of the semi-greedy scan and detection system 152a, 152b.

As shown in FIG. 4, a generalized shape traversal (GST) engine class 402 provides control for scan traversals across one or more instances of a rectangle class 412 of a virtual layout by cooperating through several classes, including an axon class 404, dendrite class 406, active domains class 408, and domain class 410. A traversal algorithm may be implemented as a method in a generalized shape traversal (GST) engine class (e.g., software module in object-oriented programming) in cooperation with several modules and/or data structures. The scan line traversal for each layer being processed is managed by a class that is referred to as “MRecIter” (denoted by reference numeral 414), which provides for multiple rectangle iterations. The black or colored polygon, for example at one end of the connecting line between the active domains class 408 and the domain class 410, represents containment. The clear or non-colored polygons at one end of the connecting lines between the active domains class 408 and the rectangle class 412 and between the domain class 410 and the rectangle class 412 represent aggregation. “Containment” refers to the ability to contain, or reference, and “own” other components within a component. For example, in FIG. 4, the color-filled polygon represents that an instance of the active domains class 408 contains and owns one or more instances of a domain class 410. For example, if an instance of the active domains class 408 is deleted from memory, all instances of the domain class 410 would also be deleted from memory. “Aggregation” refers to containment without “ownership.” For example, an instance of the rectangle class 412 has coordinates that are contained in an instance of the domain class 410 as represented by the non-color-filled polygon. If during the progression of a scan traversal in a manner similar to that described in FIGS. 3A-3G the semi-greedy scan and detection system 152a, 152b no longer encompassed coordinate data corresponding to an instance of the rectangle class 412 (e.g., no longer locally cached the coordinate data for evaluation or, conceptually, no longer within the dotted line 316, FIGS. 3A-3G), the removal of an instance of the domain class 410 does not necessarily mean the rectangle referenced by the instance of the domain class 410 is removed or purged from memory. For instance, the modules for the semi-greedy scan and detection system 152a, 152b may be in a different portion of memory 214 (FIG. 2A) than the object coordinates of the virtual layout.

The terms “axon” and “dendrite” are borrowed from artificial intelligence literature. The axon class 404 is a class (or data structure), an instance of which comprises a vector (e.g., array) of instances of the dendrite class 406 shown in FIG. 4. The dendrite class 406 is a class (or data structure) that manages the state of its active domains class 408. An instance of the active domains class 408 can comprise an unordered vector or list of instances of the domain class 410. In one embodiment, instances of the axon class 404 can be configured as a linked list of one or more instances of the dendrite class 406, and instances of the dendrite class 406 can be configured as a linked list of an instance of the active domains class 408 (and an instance of the active domains class 408 can be configured as a linked list of one or more instances of the domain class 410).

A domain class 410 is active if the scan line (e.g., as conceptually represented by arrowhead 314 in FIGS. 3A-3G) has not exceeded the top edge (top edge rectangle coordinate data) of at least one of the corresponding rectangles of the rectangle class 412 that the domain class 410 references. The dendrite class 406 represents a layer of interest of a virtual layout. There is generally one dendrite class per layer. Each dendrite class 406 has a state that is either “on” or “off” to indicate whether the layer of interest has any data on the current scan line. For example, an instance of the dendrite class 406 is either “on” if it has features on the scan line being processed (e.g., evaluated), or it is “off.” In other words, if an instance of a dendrite class 406 is empty (e.g., no instances of a domain class 410), then it is in the off state, since there is no need to check for connectivity flaws in an instance of an empty dendrite class 406. If the dendrite 406 is updated during a scan, then this update indicates that at least one instance of a domain class 410 in an instance of the active domains class 408 has changed its state.

In one embodiment, an instance of a domain class 410 can be in one of three states. When a scan line traversal has encountered the leading edge of a rectangle, the instance of the domain class 410 corresponding to the leading edge encountered is in a “beginning” state. When the scan line traversal encounters the top edge of a rectangle, the instance of the domain class 410 corresponding to the top edge is in an “end state.” Traversals between these two states cause the instance of the domain class 410 to be in a “continuing” state. A check or query for connectivity flaws occurs every time or substantially every time a new rectangle is encountered by the traversal algorithm. Further, the rectangle is checked against all instances of the dendrite class 406 that have locally cached data (e.g., corresponding conceptually to rectangles located within the dashed line 316 of FIGS. 3A-3G).

FIG. 5 is a schematic diagram used to illustrate an embodiment of a realization in memory 214 (FIG. 2A) of the example software architecture of the semi-greedy scan and detection system 152a, 152b shown in FIG. 4. As indicated above, an instance of a class is considered an object, and thus instead of referring below to an instance of the class, for brevity, it will be understood that the term “object,” is an instance of a class. For example, an instance of a domain class 410 (FIG. 4) is referred to as a domain object 510. The “blocks” in FIG. 5 thus now reference objects. Referring to FIG. 5, shown is an MRectIter object 514 that cooperates with the GST engine object 502 to implement scan-traversals, and an axon object 504 that comprises two dendrite objects 506a and 506b. The dendrite object 508a and the dendrite object 508b comprise an active domains object 508a and 508b, respectively. The domain objects of the active domains object 508a include domain objects 510a and 510b, although fewer or more are possible, the latter represented by the dotted line beneath the domain object 510b. The domain objects of the active domains object 508b include domain objects 510c and 510d, although fewer or more are possible, the latter represented by the dotted line beneath the domain object 510d. Each domain object 510a or 510b of the active domains object 508a corresponds to a rectangle object 512a, 512b, respectively, of a virtual layout. Similarly, each domain object 510c or 510d of the active domains object 508b corresponds to a rectangle object 512c, 512d, respectively, of a virtual layout. Rectangle objects will be referred to as just “rectangles,” with the understanding that the rectangles used herein are simply objects in memory. The domain object 510a is an instance of a class (or data structure) that contains the rectangle coordinate data for rectangle 512a, and the domain object 510b is an instance of a class (or data structure) that contains the rectangle coordinate data for rectangle 512b. The coordinate data included in the domain object 510a, for example, can include the left and right ends (e.g., x-coordinates) of the rectangle 512a and the height or range (e.g., y-coordinates) of the rectangle 512a. Similar explanation applies to the branch from the domain object 504 corresponding to the dendrite object 506b, and thus will be omitted for brevity.

Continuing the description using domain object 510a and rectangle 512a, with the understanding that the description similarly applies to other domains and rectangles, such as domain object 510b and corresponding rectangle 512b, the domain object 510a represents a true domain in the mathematical sense along the x-axis, where its definition requires a left and a right endpoint. The domain object 510a maintains a reference to the rectangle 512a that it represents in the virtual layout and a state variable for removing or disregarding irrelevant data. The number of rectangles per dendrite object 506a varies depending at least in part on whether a layer is configured horizontally or vertically oriented rectangles.

As each rectangle from any layer in a virtual layout (e.g., virtual layout 104b, FIG. 1B) is encountered, its corresponding domain object is added to a dendrite object corresponding to its layer. Thus, as shown in FIG. 5, the dendrite object 506b corresponds to one layer of rectangles 512c and 512d, as represented by the clear-colored rectangles 512c. Further, the dendrite object 506a corresponds to another layer of rectangles 512a and 512b, as represented by the dark-colored rectangles. As the scan traversal progresses, dendrite objects are kept “trimmed” (e.g., data that is irrelevant is removed) by removing any domain objects from consideration by the semi-greedy scan and detection system 152a, 152b (FIGS. 2A and 2B) whose ranges (e.g., top edge of a rectangle) have ended. In this way, as each rectangle is processed to check for connectivity flaws or other design flaws or events, only the locally available data (e.g., cached data or conceptually-speaking, encompassed by the dashed line 316, FIGS. 3A-3G)) of the relevant dendrite objects is available.

Summarizing, as a scan line traversal proceeds, a domain object is instantiated every time that a leading edge of a rectangle is encountered, resulting in a “beginning” state for the domain object. When a scan line changes (e.g., in the x-direction), the state of the domain object is changed to indicate that the rectangle it references is still active (e.g., “continuing” state), as described above. If the scan line change causes an encounter with the top edge of the rectangle, then the end of the rectangle is reached and the domain object's state is updated to an “end” state to reflect this. In one embodiment, the MRecIter object 514 returns the next, left-most domain object (corresponding to the lowest y-coordinate rectangle closest to the x-coordinate origin of the virtual layout) in the current scan line after an incremental change in the y-direction, regardless of which layer it comes from. In other words, the scan line returns to the left-most rectangle in a virtual layout whose leading edge is lower than other rectangles that have not yet been encountered by the scan line.

As noted above, the methodology of the semi-greedy scan and detection system 152a, 152b (FIGS. 2A and 2B) is described as semi-greedy (as opposed to “greedy”) because the potential for the local data to grow is high, especially for virtual layers whose domain objects have large ranges, such as for virtual layers with vertically-laid rectangles. To aid with this problem of data growth, as each relevant dendrite object is traversed, irrelevant data is removed or disregarded (“trimmed”) and checks for connectivity flaws or other design flaws continue if the data cannot be discarded. As described above, an optimal solution is found by making local choices. The local choices use the information available on the “trimmed-on” dendrite objects corresponding to each layer. Further, as a sweep of the virtual layout of the chip occurs, an optimal solution exists up to that point. In other words, the scan and detect mechanisms of the semi-greedy scan and detection system 152a, 152b can start and end at any scan line.

FIG. 6 is a flow diagram that illustrates an embodiment of a scanning and connectivity flaw detection methodology of the software architecture shown in FIG. 4. Step 602 includes initializing all relevant objects. In other words, instances of classes or data structures are created in memory 214 (FIG. 2A) before starting a scan traversal. Step 604 includes opening a scan-based traversal of every registered virtual layer. For example, the MRectIter object 514 (FIG. 5) is preferably used to open a scan-based traversal. For every domain object returned by the MRectIter object 514, several steps are implemented. Step 606 includes querying whether a scan line change has occurred. If the scan line changes, then the state of every domain object in any active dendrite object is updated (step 608). A scan line change in the x-direction will change the state of a domain object corresponding to a past encountered rectangle from a “beginning” state to a “continuing” state. A scan line change in the y-direction may change the state of any domain objects since traversed from a “continuing” state to an “end” state, or the state may be maintain at “continuing.” If the scan line has not changed (or after the update from step 608), a new domain object is added (step 610) to its corresponding dendrite object in the axon object.

Step 612 includes querying whether a connectivity flaw has been detected. Such a connectivity flaw may include touches, overlaps, etc. If a connectivity flaw is detected, a callback can be made (step 614) to a client application, module, device, etc., to take whatever actions the designer has chosen to be made in response to such a connectivity flaw detection. In one embodiment, pointers to functions to build the callback mechanism for client applications can be used. A client application basically implements a function and passes its pointer to a GST engine object, for example GST engine object 502 (FIG. 5). The engine object, in turn, calls this function when it encounters a connectivity flaw between two or more objects. In the examples described herein, the objects happen to be rectangles that represent wires or blocks in some layer of the chip. The client application then decides what to do with the connectivity flaw. Other mechanisms for implementing a callback can be found in the related utility application incorporated by reference in the first section of the current utility application. If a connectivity flaw has not been detected (or after the callback has been implemented from step 614), an additional query is made in step 616 to determine if a range has expired (e.g., referring to FIG. 5, has the top edge coordinates of a rectangle 512a, 512b for an active domain object been exceeded). If the range has expired, a post-processing step occurs for all dendrite objects such that any domains objects corresponding to rectangles whose ranges have expired are removed (step 618). Step 618 enables local data to be trimmed and maintained as greedy, and the scan traversal continues (step 620). If the range has not expired, the scan traversal continues (step 520) and then steps starting at step 506 are repeated.

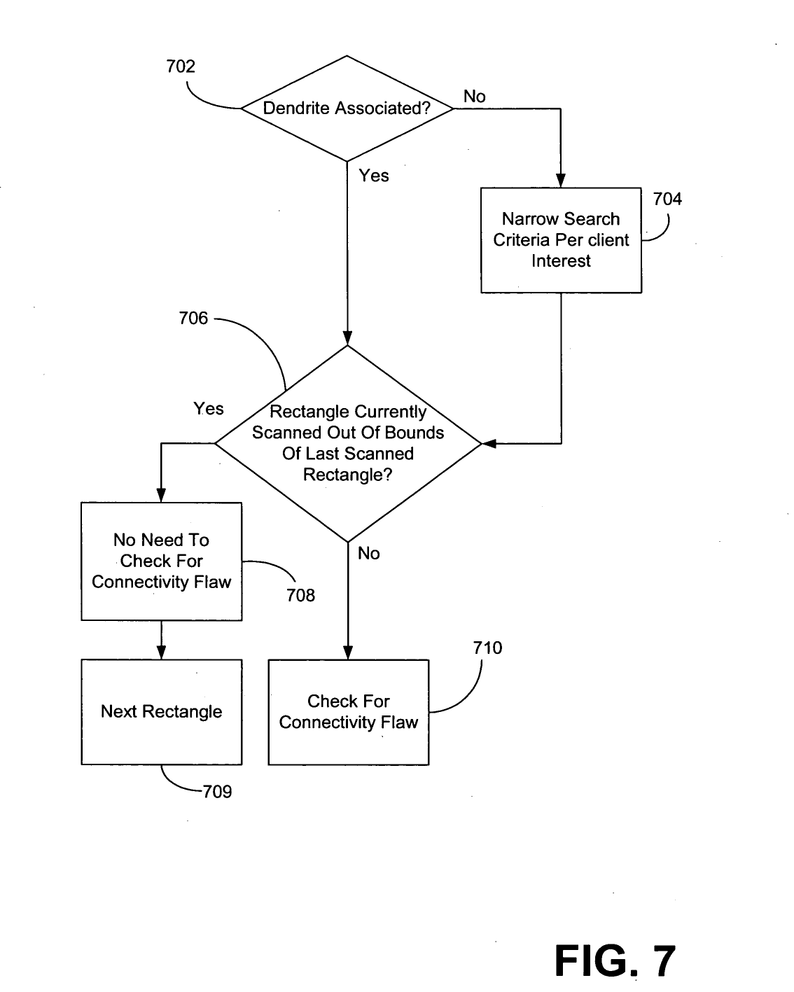

FIG. 7 is a flow diagram that further illustrates the connectivity flaw detection step (step 612) shown in FIG. 6. For every or substantially every dendrite object having an active domain in the axon object, a query is made to determine if a specified dendrite object is associated (step 702). Dendrite objects are associated if a client application expresses an interest in connectivity flaws between the layers represented by these dendrite objects. If the dendrite object is not associated, step 704 includes narrowing the search to only the dendrite objects that are associated. Proceeding to step 706 (e.g., if the dendrite object is associated from step 702 or if the search has been narrowed in step 704), a query is made for every domain object in the active domains object to determine if the current domain object (at the scan line coordinate) is too far to the right, the left, or higher (e.g., outside the bounds, or rather, outside the range and x-coordinates) than the rectangle(s) we are checking against (i.e., domain objects of past-scanned cached rectangles). In other words, if the domain objects corresponding to rectangles having cached coordinate data are within the range of the rectangle to which the scan line is currently encountering, then coordinates along the x-direction are evaluated for the connectivity flaw. If outside the bounds, then clearly no connectivity flaw will occur, and thus there is no need to check for connectivity (step 708). The scan line then proceeds to the next rectangle (step 709). If within the bounds, processing continues to step 710 (or if the answer to the query of step 706 is “no”) wherein a check for connectivity flaws is made.

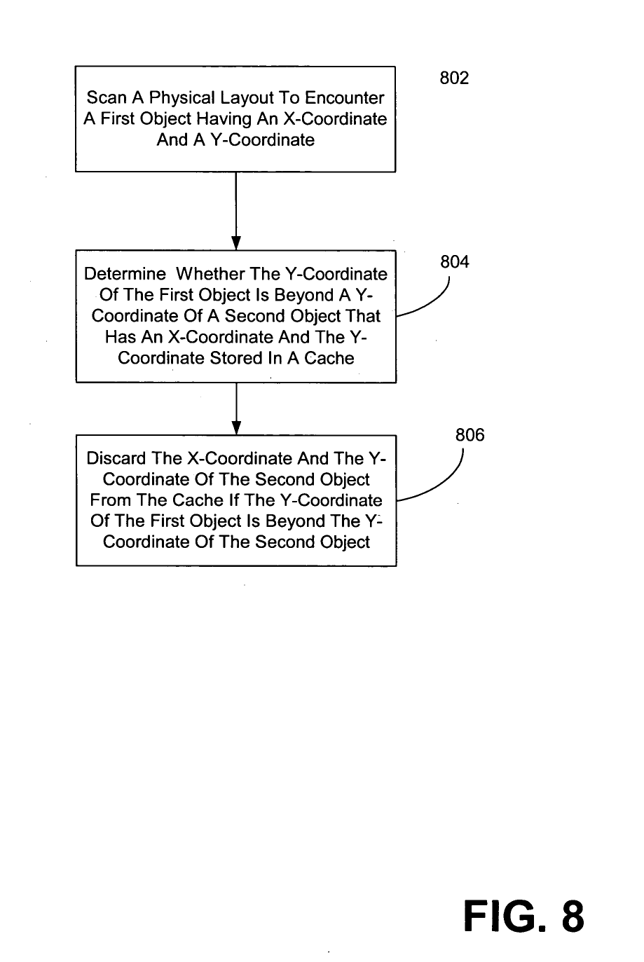

FIG. 8 is a flow diagram that illustrates an embodiment of a scanning and detection methodology of the semi-greedy scan and detection system 152a, 152b of FIGS. 2A-2B. Step 802 includes scanning a virtual layout to encounter a first object having an x-coordinate and a y-coordinate. Step 804 includes determining whether the y-coordinate of the first object is beyond a y-coordinate of a second object that has an x-coordinate and the y-coordinate stored in a cache. Step 806 includes discarding the x-coordinate and the y-coordinate of the second object from the cache if the y-coordinate of the first object is beyond the y-coordinate of the second object.

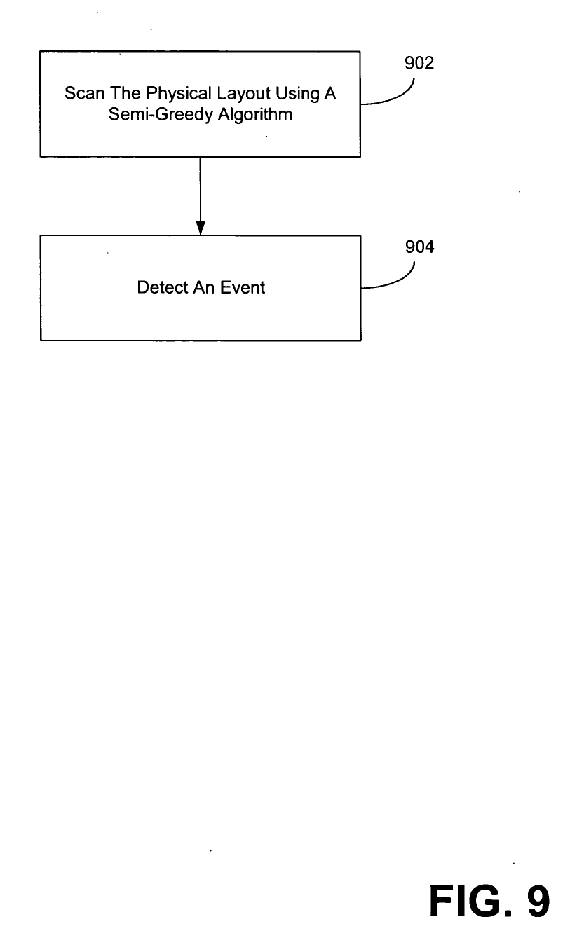

FIG. 9 is a flow diagram that illustrates a generalized scanning and event detection methodology of the semi-greedy scan and detection system of FIGS. 2A and 2B according to an embodiment of the invention. Step 902 includes scanning the virtual layout using a semi-greedy algorithm. Step 904 includes detecting an event.

Any process descriptions or blocks in the aforementioned flow diagrams should be understood as representing modules, segments, or portions of code which include one or more executable instructions for implementing specific logical functions or steps in the process, and alternate implementations are included within the scope of the various embodiments of the invention in which functions may be executed out of order from that shown or discussed, including substantially concurrently or in reverse order, depending on the functionality involved, as would be understood by those reasonably skilled in the art of the present invention.

The semi-greedy scan and detection system may perform better in implementations comprising primarily horizontally-configured layers than vertically-configured layers since vertically-configured layers contain large numbers of “stretched-out” rectangles in the y-axis direction, thus forcing the semi-greedy scan and detection system to keep this information around longer, which may make the search for events more time-consuming. For horizontal layers, where the rectangles are “stretched-out” along the x-axis, the data to maintain is small, thus often enabling a less time-consuming performance.

The semi-greedy scan and detection system can keep track of domains on a per layer basis rather than a per scan line basis, enabling queries a layer at any time for its current state. Additionally, the semi-greedy scan and detection system enables reflexive traversals by specifying a single layer, although multiple layer associations can be specified. The semi-greedy scan and detection system can report the connectivity of each of these associations with a single pass through the virtual layout of the chip.

1. A method for analyzing a virtual layout of a semiconductor chip, comprising:
scanning a virtual layout to encounter a first object having an x-coordinate and a y-coordinate;
determining whether the y-coordinate of the first object is beyond a y-coordinate of a second object that has an x-coordinate and the y-coordinate stored in a cache; and
discarding the x-coordinate and the y-coordinate of the second object from the cache if the y-coordinate of the first object is beyond the y-coordinate of the second object.

2. The method of claim 1, further including, responsive to determining that the y-coordinate of the first object is not beyond the y-coordinate of the second object, storing the x-coordinate and the y-coordinate of the first object in the cache.

3. The method of claim 2, further including detecting for the presence of a design flaw between the first object and the second object.

4. The method of claim 3, wherein the design flaw includes at least one of touches between objects, overlaps between objects.

5. The method of claim 3, wherein the detecting occurs across at least one of a single layer and multiple layers.

6. The method of claim 1, further including reporting the design flaw.

7. The method of claim 1, wherein the first object and the second object include geometric objects of a virtual layout, the geometric objects representing structures in a microchip.

8. A method for analyzing a virtual layout of a semiconductor chip, comprising:
scanning a virtual layout using a semi-greedy algorithm; and
detecting an event.

9. The method of claim 8, further including reporting the event.

10. The method of claim 8, wherein the event includes at least one of touches between objects, overlaps between objects, last encounter with an object, first encounters with an object, a parameter of an object.

11. A system for scanning a virtual layout of a microchip design, comprising:
scan and detection logic configured to scan a virtual layout to encounter a first object having first coordinates, store a second object having second coordinates in a cache, determine whether the first coordinates are outside the range of the second coordinates, and discard the second coordinates from the cache if the first coordinates are outside the range of the second coordinates.

12. The system of claim 11, wherein the scan and detection logic are comprised of instantiations of at least one of an axon class, a dendrite class included in the axon class, an active domains class included in the dendrite class, a domain class included in the dendrite class, a traversal engine class configured to perform scan traversals of the virtual layout, and a rectangle iterator class that manages the scan traversals over multiple objects of the virtual layout.

13. The system of claim 12, wherein the instantiations of the axon class, the dendrite class, the active domains class, the domain class, the traversal engine class, and the rectangle iterator class are each configured as independent modules.

14. The system of claim 12, wherein the instantiations of the axon class, the dendrite class, the active domains class, the domain class, the traversal engine class, and the rectangle iterator class are collectively configured as a single module.

15. The system of claim 12, wherein the instantiations of the domain class includes a state that is updated for each scan line change.

16. The system of claim 12, wherein the instantiations of the dendrite class includes instantiations of multiple domain classes, wherein each instantiation of the domain class corresponds to an object in the virtual layout.

17. The system of claim 12, wherein the scan and detection logic is further configured to, responsive to determining that the first coordinates are not outside the range of the second coordinates, store the first coordinates in the cache.

18. The system of claim 17, wherein the scan and detection logic is further configured to detect whether an instantiation of a domain class corresponding to the first object includes coordinates that give rise to a design flaw with coordinates included in an instantiation of a domain class corresponding to the second object.

19. The system of claim 12, wherein the scan and detection logic are configured to discard a state of the domain object corresponding to the second coordinates.

20. The system of claim 11, wherein the scan and detection logic are configured in a digital signal processor.

21. The system of claim 11, wherein the scan and detection logic are configured as software in communication with a processor.

22. A scan and detection system comprising:
means for traversing a virtual layout of a microchip design;
means for detecting whether a first object has coordinates within a range of coordinates of a second object stored in a cache; and
means for discarding the coordinates of the second object when the first object has coordinates outside the range of coordinates of the second object.

23. The system of claim 22, further including means for storing the coordinates of the first object in the cache.

24. The system of claim 23, further including means for detecting a design flaw between the first object and the second object.

25. A computer readable medium having a computer program for scanning and detecting connectivity between structures in a virtual layout, the program comprising:
logic configured to scan objects of a virtual layout using a semi-greedy algorithm; and
logic configured to detect an event.

26. The computer readable medium of claim 25, wherein the logic includes data structures that reference the objects of the virtual layout.

27. The computer readable medium of claim 26, wherein the data structures are configured as at least one of a linked list, a tree list, and classes.
